(19) United States
(12) Patent Application Publication
(10) Pub. No.: US 2016/0380657 A1
(43) Pub. Date: Dec. 29, 2016

(54) INTERFERENCE CANCELLATION

(71) Applicant: Intel IP Corporation, Santa Clara, CA (US)

(72) Inventors: Hang Zhou, Lake Zurich, IL (US); Bryan S. Nollett, Lake Zurich, IL (US); Axel Clausen, Munich (DE)

(21) Appl. No.: 14/751,959

(22) Filed: Jun. 26, 2015

(51) Int. Cl. H04B 1/10; H04W 72/08; H04W 72/00

(52) U.S. Cl. CPC H04B 1/10; H04W 72/005; H04W 72/082

(57) ABSTRACT

A method for interference cancellation in a wireless communication receiver including a signal generator configured to regenerate, from a communication signal received from a plurality of cells, an interference signal of a current subframe of a cell for which information bits are known; and a subtractor configured to subtract the regenerated interference signal from the received communication signal, or from a buffered communication signal having interference of one or more cells cancelled.

### TECHNICAL FIELD

The present disclosure generally relates to interference cancellation, and more specifically, to a receiver and method for prospective successive interference cancellation.

### BACKGROUND

Further enhanced Inter-Cell Interference Coordination (FeICIC) in 3rd Generation Partnership Project (3GPP) Long Term Evolution (LTE) Release 11 improves capacity in heterogeneous networks. In a heterogeneous network, a user equipment may encounter interference from nearby macrocells and/or picocells. The user equipment's received Physical Broadcast Channel (PBCH) signal is a composite signal of the serving cell's PBCH signal and the interfering cells' PBCH signals. The PBCH carries the Master Information Block (MIB), which includes parameters used for a user equipment's initial access to a cell. Successfully decoding the PBCH signal is necessary for subsequent decoding of control and data channels, and thus the user equipment needs to perform interference mitigation.

### BRIEF DESCRIPTION OF THE DRAWINGS

FIG. 1 illustrates a schematic diagram of a wireless communication system having a prospective successive interference cancellation receiver.

FIG. 2 illustrates a schematic diagram of PBCH signal subframes subjected to a prospective successive interference cancellation method.

FIG. 3 illustrates a flowchart of the prospective successive interference cancellation method.

FIG. 4 illustrates a schematic diagram of a wireless communication system.

### DETAILED DESCRIPTION

The present disclosure is directed to progressive successive interference cancellation (SIC) on a received Physical Broadcast Channel (PBCH) signal. The interference cancellation is progressive in that once a cell's PBCH has been decoded, that PBCH signal is subtracted from the present and future received composite PBCH signals, but not from historic signals. As a result, no buffering of historic PBCH signals or historic channel estimates is required.

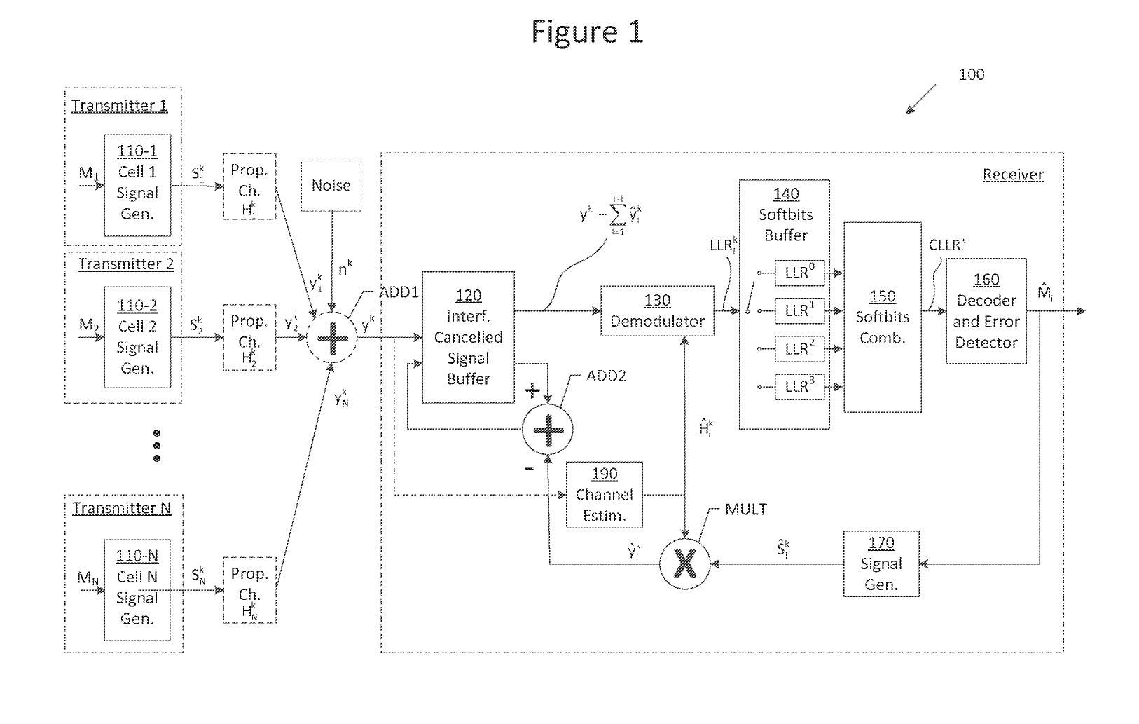

FIG. 1 illustrates a schematic diagram of a wireless communication system 100 having a prospective successive interference cancellation receiver.

The communication system has transmitters 1 . . . N serving respective cells 1 . . . N, and a user equipment receiver. Each transmitter includes a signal generator 110-i (i=1 . . . N). The N cells 1 . . . N are shown in the order of their signal strength at the receiver, with cell 1 being the strongest and cell N being the weakest.

The signal generator 110-i is configured to receive uncoded information bits Mᵢ of the PBCH signal, including the Master Information Block (MIB), and generate a signal Sᵢ^{k} representing coded PBCH signal bits for cell i in subframe k. The information bits Mᵢ are used to generate the PBCH signal Sᵢ^{k} transmitted from a cell i in a first subframe of every radio frame for four consecutive radio frames (k=0, 1, 2, and 3). In other words, the same information bits Mᵢ are transmitted four times and the corresponding received PBCH signals Sᵢ^{k} can be combined at the receiver. Not every subframe has PBCH signal bits. Any PBCH signal or valid combination of PBCH signals within the four radio frames can lead to the decoding of the same information bits Mᵢ.

The propagation channel Hᵢ^{k} is experienced by cell i's generated PBCH signal Sᵢ^{k} in subframe k. Signal yᵢ^{k}=Hᵢ^{k}Sᵢ^{k} represents the signal transmitted through the propagation channel Hᵢ^{k} from cell i in subframe k. The transmitted signals yᵢ^{k} from different cells arrive at the receiver and are observed by the receiver in subframe k as a composite signal

$${y}^{k} = {\sum }_{l = 1}^{N} {y}_{l}^{k} + {n}^{k} ,$$

where N is the number of cell and n^{k} is noise. The adder ADD1 shown in the figure is not a physical unit, but instead represents the combination of the transmitted signals and noise to result in the composite communication signal y^{k}.

The receiver includes an interference cancelled signal buffer 120, a demodulator 130, a softbits buffer 140, a softbits combiner 150, a decoder and error detector 160, a signal generator 170, a complex multiplier MULT, an adder ADD2, and a channel estimator 190.

The interference cancelled signal buffer 120 is configured to receive the composite PBCH signal y^{k} from the transmitters 1 . . . N, and interference cancelled signals from the adder ADD2, and buffer the post interference cancellation result

$${y}^{k} - {\sum }_{l = 1}^{l - 1} {\hat{y}}_{l}^{k} ,$$

as will be described further below.

The demodulator 130 is configured to receive the post interference cancellation result

$${y}^{k} - {\sum }_{l = 1}^{l - 1} {\hat{y}}_{l}^{k}$$

and generate softbits LLRᵢ^{k} for cell i in subframe k. These softbits LLRᵢ^{k} are stored in the softbits buffer 140 as LLR⁰, LLR¹, LLR², LLR³ for respective subframes 0 . . . 3 of a particular cell i according to subframe k.

The softbits combiner 150 is configured to combine any combination of buffered softbits to produce combined softbits CLLRᵢ^{k}. Commonly, for the first subframe 0 the combined softbits CLLRᵢ⁰ is merely LLRᵢ⁰. For the second subframe 1, the combined softbits CLLRᵢ¹ is a combination of any of the first softbits LLRᵢ⁰ and the second softbits LLRᵢ¹. For the third subframe 2, the combined softbits CLLRᵢ² is a combination of any of the first softbits LLRᵢ⁰, the second softbits LLRᵢ¹, and the third softbits LLRᵢ². The combined softbits CLLRᵢ^{k} are used to decode cell i in subframe k. The manner of combining softbits may be based on the 3GPP standard, for example, and is outside the scope of this disclosure.

The decoder and error detector 160 is configured to decode information bits Mᵢ of the intended PBCH signal using the combined softbits CLLRᵢ^{k}. Error detection is performed to determine whether the information bits Mᵢ decoded successfully. \hat{M}ᵢ represents a successfully decoded cell i's information bits. The decoder and error detector 160 is shown as a single unit, but these two functions may alternatively be performed by separate units.

The signal generator 170 is configured to, if the information bits \hat{M}ᵢ decoded successfully, regenerate a re-encoded signal Ŝᵢ^{k} for cell i in subframe k. The same information bits \hat{M}ᵢ results in different re-encoded signals Ŝᵢ^{k} for different subframe k's.

The channel estimator 190 has an input represented in dash-line because channel estimation is an implementation detail that is not relevant to this disclosure. Channel estimation is required for both demodulation and interference signal regeneration, though. Ĥᵢ^{k} represents an estimated channel for cell i's signal in subframe k.

The complex multiplier MULT multiplies the re-encoded signal Ŝᵢ^{k} from the signal generator 170 by the estimated channel Ĥᵢ^{k} to result in a regenerated interference signal ŷᵢ^{k} from cell i in subframe k.

The adder ADD2 is configured to subtract the regenerated interference signal ŷᵢ^{k} from the post interference cancellation signal

$${y}^{k} - {\sum }_{l = 1}^{l - 1} {\hat{y}}_{l}^{k}$$

that is stored in the interference cancelled signal buffer 120 and store therein an updated post interference cancellation result

$${y}^{k} - {\sum }_{l = 1}^{l} {\hat{y}}_{l}^{k} .$$

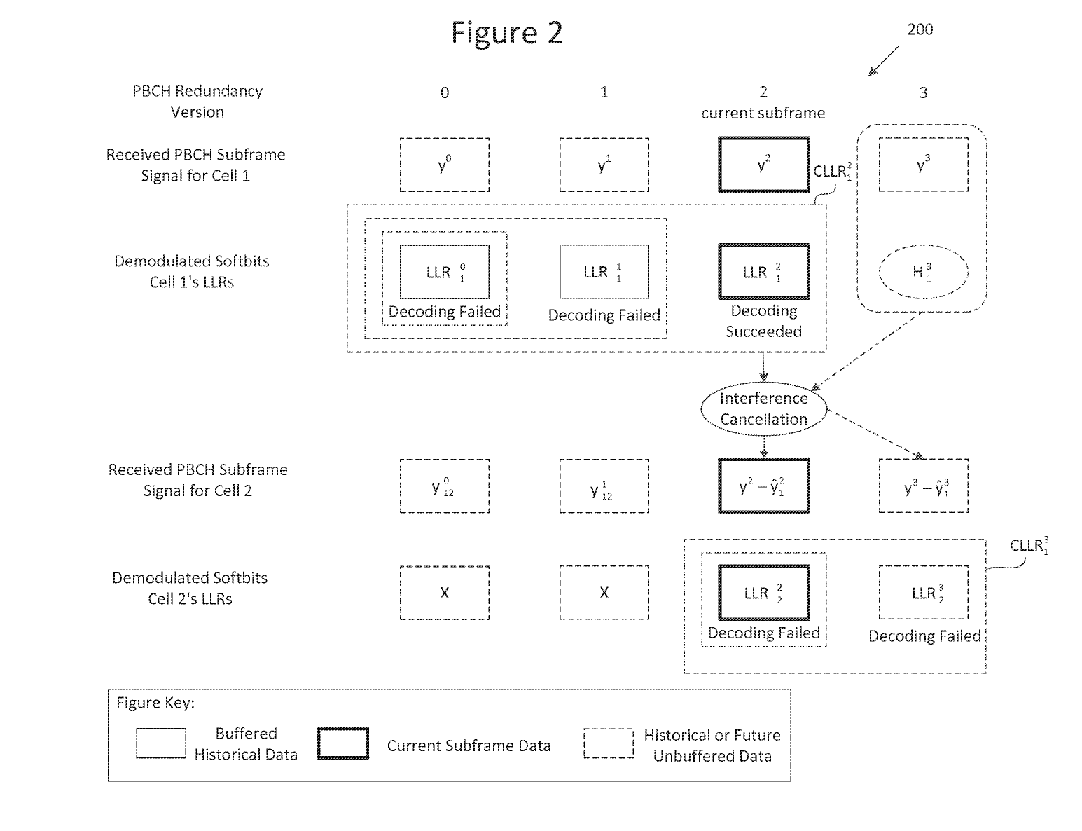

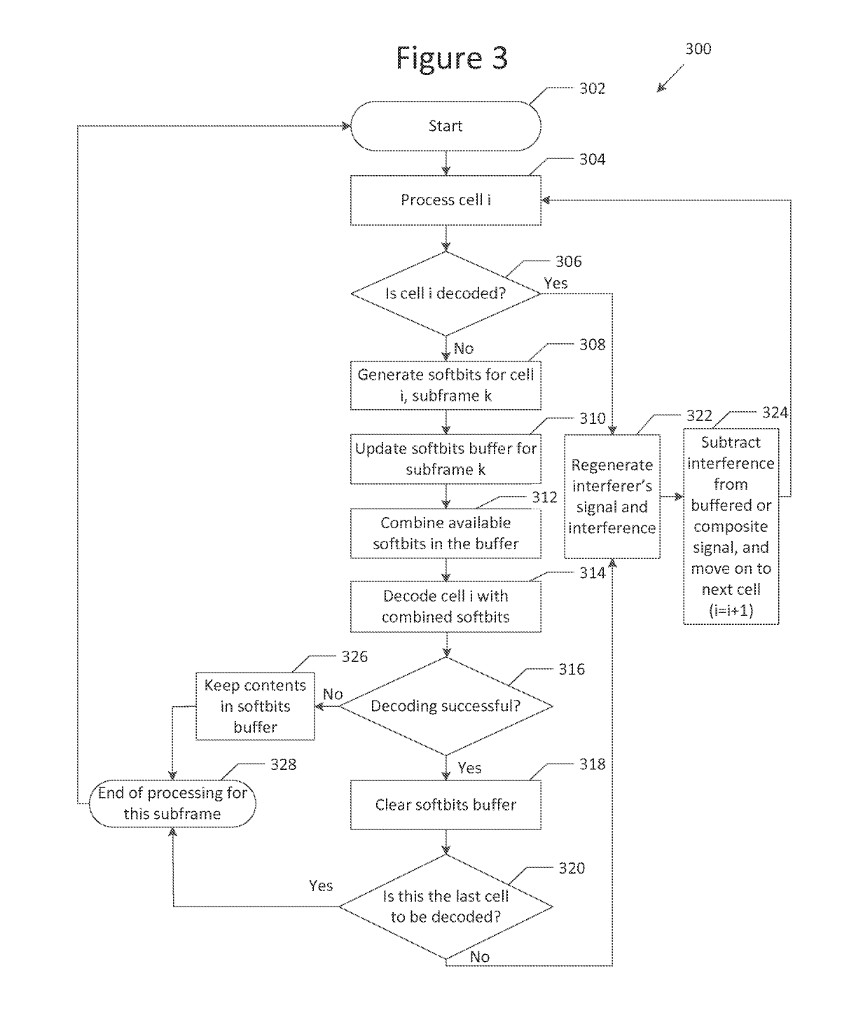

If there is not yet an interference cancelled signal stored in the buffer 120, the regenerated interference signal ŷᵢ^{k} can be subtracted from the received composite communication signal y^{k}. The interference cancelled signal buffer 120 permits subtraction of interference contributions of multiple cells, and storage of the subtracted values back in the buffer 120. It is thus possible to iteratively subtract contributions of the individual cells in order, that is, the contribution of the first cell, then the second cell, etc. FIG. 2 illustrates a schematic diagram 200 of PBCH signal subframes subjected to a prospective successive interference cancellation method, which is described in more detail below with respect to FIG. 3.

By way of overview, in FeICIC systems, an effective way of mitigating interference is to perform successive interference cancellation (SIC) on the composite PBCH signal y^{k}. Since the MIB, carried by the PBCH, for a given cell, once successfully decoded, can be assumed to be known for a significant duration after that successful decoding, the user equipment receiver encountering strong synchronous-cell interference of its PBCH signal can sequentially decode each interferer cell's PBCH signal, starting from the interfering cell with the strongest power (i.e., cell 1), regenerate the interference signal from that interferer cell, and then subtract the regenerated interference signal from the received composite PBCH signal y^{k}. The user equipment receiver performs such successive decoding, regeneration and cancellation for the different cells 1 . . . N successively in order of their signal strength, from strong to weak, until the desired PBCH signal has a high enough signal-to-interference-plus-noise ratio (SINR) to be decoded successfully. This is reflected by the feedback loop of the receiver; the input for the demodulator 130 of cell i is the composite signal y^{k} minus the regenerated received PBCH signals from cells having stronger interference.

In FIG. 2 the first row represents the composite PBCH signal indices of PBCH transmissions k=0 . . . 3, in the first subframe of each of four frames. Again, the composite PBCH signal is a composite signal of the serving cell's PBCH signal and the interfering cells' PBCH signals. The second row represents the received composite PBCH subframe signals y^{k}. The third row represents cell 1's demodulated softbits LLR₁^{k}, with CLLR₁² representing a combination of the softbits for subframes 0, 1, and 2 (LLR₁⁰, LLR₁¹, and LLR₁², respectively). The fourth row represents the interference-cancelled received PBCH subframe signals for cell 2. The fifth row represents cell 2's demodulated softbits LLR₂^{k}.

The solid-line boxes represent buffered historical data, the bolded solid-line boxes represent current subframe data, and the dotted-line boxes represent historical or future unbuffered data. The historical data was buffered in prior retrospective SIC methods, but in the prospective SIC method of this disclosure is not required.

The processing of the PBCH signal starts from the strongest cell from the perspective the user equipment receiver, in this case cell 1. Once cell 1 is decoded successfully, processing proceeds to the next strongest cell, in this case cell 2.

For cell 1, processing begins with the first subframe of the PBCH signal, that is, subframe 0. In this example the decoding of the softbits LLR₁⁰ fails. The softbits LLR₁⁰ for the first subframe 0 are stored so that they may later be combined into first-second combined softbits CLLR₁¹ with those softbits that will be obtained from the processing of the second subframe 1. In the second subframe 1, decoding is performed using any combination of subframe 0's softbits LLR₁⁰ and subframe 1's softbits LLR₁¹, that is, first-second combined softbits CLLR₁¹ for subframe 1. Since in this example the processing of subframes 0 and 1 do not result in successful decoding, and thus the processing does not proceed to cell 2 for its corresponding subframes.

For third subframe 2, with the additional reception of the PBCH signal y², the newly first-second-third combined softbits CLLR₁² (combining any of softbits LLR₁⁰, LLR₁¹, and LLR₁² from subframes 0, 1, and 2, respectively) leads to successful decoding. Interference signal regeneration and cancellation follow for subframes 2 and 3. Since historical data of the PBCH signal y⁰ at subframe 0 and PBCH signal y¹ at subframe 1 were not stored, the interference cancellation is performed only from where the decoding succeeded, which is subframe 2. Also, the stored softbits LLR₁^{k} for the decoded cell 1 are no longer needed and can be discarded.

Once cell 1 is successfully decoded, the decoded information bits M₁ from cell 1 are used for cell 2. More specifically, the decoded information bits M₁ from cell 1 are used to re-encode, that is regenerate the received signal ŷ₁² of cell 1, which is then subtracted from the composite signal y² (using the lower feedback path in block diagram FIG. 1). The result (y²−ŷ₁²) is then used to demodulate cell 2, that is generate softbits LLR₂².

For the fourth subframe 3, the information bits M₁ of cell 1 is decoded and thus known. These information bits M₁ are used to directly re-encode and regenerate the received signal ŷ₁³ of cell 1 in this subframe 3. The result (y³−ŷ₁³) is then used to by demodulator 130 to generate softbits LLR₂³.

In this example, combining LLR₂² and LLR₂³ does not lead to successful decoding. However, since cell 1's MIB and thus the PBCH signal is known, the prospective interference cancellation method can continue to be performed in the next four PBCH signal subframes where the user equipment receiver can potentially combine four of cell 2's PBCH signal subframes and decode its PBCH signal.

Note that the information bits M₁′ will change for the next four subframes, but the change can be deterministically derived from M₁ in most cases. Thus, the interference regeneration and cancellation is the same as was used for cell 1 in the first four subframes. However, if the information bits of cell 2 also change next, then the stored softbits LLR₂² and LLR₂³ are no longer valid and may be discarded.

FIG. 3 illustrates a flowchart 300 of the prospective successive interference cancellation method.

The method of the flowchart 300 starts at Step 302 for the first cell, i=1. To be consistent with the example illustrated in FIG. 2 described above, at Step 304 it is assumed that the first two subframes, k=0 and k=1, have already been processed, and the current subframe being processed is the third subframe, k=2.

At Step 306, it is determined if cell 1 has been decoded successfully. If not, the method proceeds to Step 308.

At Step 308 the demodulator 130 generates third softbits LLR₁² for a third subframe of the PBCH signal intended for the cell.

At Step 310, the softbits buffer 140 is updated with the generated third softbits LLR₁².

At Step 312, the softbits combiner 150 combines any of the third softbits LLR₁², the first softbits LLR₁⁰ of the first subframe k=0, and the second softbits LLR₁¹ of the second subframe k=1 to produce first-second-third combined softbits CLLR₁².

At Step 314, the decoder and error detector 160 decodes information bits M₁ of the PBCH signal intended for the cell using the first-second-third combined softbits CLLR₁².

At Step 316, the decoder and error detector 160 performs error detection to determine whether the information bits M₁ decoded successfully. If the information bits M₁ did not decode successfully, the method proceeds to Step 326, where the softbits are kept in the softbits buffer 140, and at Step 328 the processing for the third subframe k=2 ends. The processing may then be repeated starting again with Step 302.

On the other hand, if the information bits M₁ did decode successfully, the method proceeds to Step 318, where the first softbits LLR₁⁰, the second softbits LLR₁¹, and the third softbits LLR₁² are cleared from the softbits buffer 140.

At Step 320 it is determined if cell 1 was the last cell to be decoded. If it was, then at Step 328 the processing for the second subframe k=2 ends. Otherwise, the method continues to Step 322.

At Step 322 the signal generator 170 generates the interferer's signal. More specifically, the signal generator 170 generates the re-encoded signal Ŝ₁² for cell 1 in subframe 2 based on the decoded information bits \hat{M}₁, and then the multiplier MULT forms the product of this re-encoded signal and the estimated propagation channel Ĥ₁² for cell 1 in subframe 2 to produce the reconstructed received signal ŷ₁² from cell 1 in subframe 2. Then, at Step 324, the adder ADD2 subtracts the reconstructed received signal ŷ₁² from the from the interference cancelled signal stored in buffer 120, and if there is no interference cancelled signal stored in buffer 120, from the composite communication signal y². The method then returns to Step 304 where the post interference cancellation result

$${y}^{k} - {\sum }_{l = 1}^{l} {\hat{y}}_{l}^{k}$$

is used to demodulate the next strongest cell, that is, cell 2. After this next strongest cell 2 is demodulated successfully, then the process repeats, that is, proceeds from Step 324 to Step 304, for other cells in strength order.

Referring back to Step 306, if cell 1 had decoded successfully, then method proceeds directly to Steps 322 and 324, as described above.

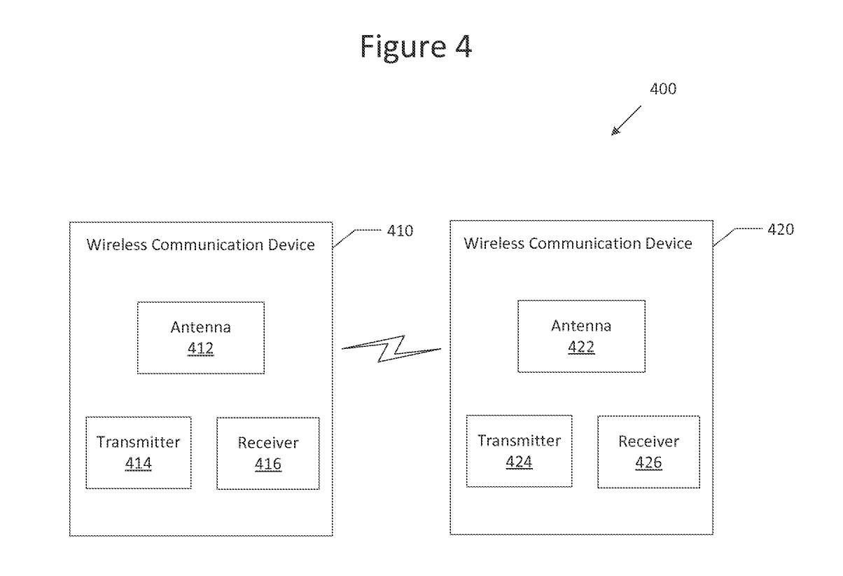

FIG. 4 illustrates a schematic diagram of a wireless communication system 400. The system 400 includes a first wireless communication device 410 and a second wireless communication device 420 that may be in wireless communication with each other. Each of the first wireless communication device 410 and the second wireless communication device 420 includes an antenna 412, 422, a transmitter 414, 424, and potentially a prospective successive interference cancellation receiver 416, 426, as described herein.

In the prospective successive interference cancellation of this disclosure, memory is saved because buffering of past received composite PBCH signals and channel estimates is not required. Instead, interference of a cell is regenerated and cancelled from present and future received PBCH transmissions after the PBCH of a cell is decoded. The cell whose PBCH is currently being decoded can buffer its soft bits for multiple PBCH subframes to improve decoding probability. To regenerate the interference of decoded cells' PBCH, current subframe channel estimates for the interfering cell can be generated on-the-fly.

Example 1 is a method of interference cancellation in a wireless communication receiver, the method comprising: regenerating, by a signal generator, from a communication signal received from a plurality of cells, an interference signal of a current subframe of a cell for which information bits are known; and subtracting, by a subtractor, the regenerated interference signal from the received communication signal, or from a buffered communication signal having interference of one or more cells cancelled.

In Example 2, the subject matter of Example 1, further comprising: generating, by a demodulator, softbits of the current subframe of a current cell.

In Example 3, the subject matter of Example 2, further comprising: storing, in a buffer, the softbits of the current subframe of the current cell.

In Example 4, the subject matter of Example 2, further comprising: combining, by a combiner, the softbits of the current subframe of the current cell with any previously stored softbits of the current cell.

In Example 5, the subject matter of Example 4, further comprising: decoding, by a decoder, information bits of the current cell using the combined softbits.

In Example 6, the subject matter of Example 5, further comprising: performing, by an error detector, error detection to detect whether the information bits of the current cell are decoded successfully.

In Example 7, the subject matter of Example 6, wherein, if the information bits are decoded successfully, further comprising: clearing from the buffer any stored softbits.

In Example 8, the subject matter of Example 6, wherein, if the information bits are decoded successfully, further comprising: repeating the regenerating and subtracting steps for the current cell; and repeating the generating, combining, decoding, and error detecting steps for another cell.

In Example 9, the subject matter of Example 6, wherein, if the information bits are decoded unsuccessfully, further comprising: repeating the regenerating and subtracting steps for a future subframe; and repeating the generating, combining, and decoding steps for the future subframe of the current cell.

In Example 10, the subject matter of Example 1, wherein the communication signal having interference of one or more cells cancelled had the interference cancelled using a prospective successive interference cancellation method.

In Example 1, the subject matter of Example 1, wherein the received communication signal is a physical broadcast channel (PBCH) signal.

In Example 12, the subject matter of Example 11, wherein the PBCH signal comprises four subframes in four respective frames.

Example 13 is a wireless communication receiver, comprising: a signal generator configured to regenerate, from a communication signal received from a plurality of cells, an interference signal of a current subframe of a cell for which information bits are known; and a subtractor configured to subtract the regenerated interference signal from the received communication signal, or from a buffered communication signal having interference of one or more cells cancelled.

In Example 14, the subject matter of Example 13, further comprising: a demodulator configured to generate softbits of the current subframe of a current cell.

In Example 15, the subject matter of Example 14, further comprising: a buffer configured to store the softbits of the current subframe of the current cell.

In Example 16, the subject matter of Example 14, further comprising: a combiner configured to combine the softbits of the current subframe of the current cell with any previously stored softbits of the current cell.

In Example 17, the subject matter of Example 16, further comprising: a decoder configured to decode information bits of the current cell using the combined softbits.

In Example 18, the subject matter of Example 17, further comprising: an error detector configured to perform error detection to determine whether the information bits of the current cell decoded successfully.

In Example 19, the subject matter of Example 18, wherein the signal generator and the subtractor are further configured to perform the regenerating and subtracting for the current cell if the information bits decoded successfully, and wherein the demodulator, the combiner, the decoder, and the error detector are further configured to perform the generating, combining, decoding, and error detecting, respectively, for another cell if the information bits decoded successfully.

In Example 20, the subject matter of Example claim 18, wherein the signal generator and the subtractor are further configured to perform the regenerating and subtracting, respectively, for a future subframe of the current cell if the information bits did not decode successfully, wherein the demodulator, buffer, combiner, and decoder are further configured to perform the generating, combining, and decoding, respectively, for a next subframe of the current cell, if the information bits did not decode successfully.

In Example 21, the subject matter of Example 13, wherein the received communication signal is a physical broadcast channel (PBCH) signal.

Example 22 is a mobile communication device comprising the subject matter of Example 13.

Example 23 is a computer program product embodied on a non-transitory computer-readable medium comprising program instructions configured such that when executed by processing circuitry causes the processing circuitry to implement the subject matter of Example 1.

Example 24 is a wireless communication receiver, comprising: a signal generating means for regenerating, from a communication signal received from a plurality of cells, an interference signal of a current subframe of a cell for which information bits are known; and a subtracting means for subtracting the regenerated interference signal from the received communication signal, or from a buffered communication signal having interference of one or more cells cancelled.

In Example 25, the subject matter of Example 24, further comprising: a demodulating means for generating softbits of the current subframe of the current cell.

In Example 26, the subject matter of any of Examples 2-3, further comprising: combining, by a combiner, the softbits of the current subframe of the current cell with any previously stored softbits of the current cell.

In Example 27, the subject matter of any of Examples 3-6, wherein, if the information bits are decoded successfully, further comprising: clearing from the buffer any stored softbits.

In Example 28, the subject matter of any of Examples 1-9, wherein the communication signal having interference of one or more cells cancelled had the interference cancelled using a prospective successive interference cancellation method.

In Example 29, the subject matter of any of Examples 1-10, wherein the received communication signal is a physical broadcast channel (PBCH) signal.

In Example 30, the subject matter of any of Examples 14-15, further comprising: a combiner configured to combine the softbits of the current subframe of the current cell with any previously stored softbits of the current cell.

In Example 31, the subject matter of any of Examples 13-20, wherein the received communication signal is a physical broadcast channel (PBCH) signal.

Example 32 is a mobile communication device comprising the wireless communication receiver of any of Examples 13-21.

Example 33 is a computer program product embodied on a non-transitory computer-readable medium comprising program instructions configured such that when executed by processing circuitry causes the processing circuitry to implement the subject matter of any of Examples 1-12.

Example 34 is an apparatus substantially as shown and described.

Example 35 a method substantially as shown and described.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A method of interference cancellation in a wireless communication receiver, the method comprising:
regenerating, by a signal generator, from a communication signal received from a plurality of cells, an interference signal of a current subframe of a cell for which information bits are known; and
subtracting, by a subtractor, the regenerated interference signal from the received communication signal, or from a buffered communication signal having interference of one or more cells cancelled.

2. The method of claim 1, further comprising:
generating, by a demodulator, softbits of the current subframe of a current cell.

3. The method of claim 2, further comprising:
storing, in a buffer, the softbits of the current subframe of the current cell.

4. The method of claim 2, further comprising:
combining, by a combiner, the softbits of the current subframe of the current cell with any previously stored softbits of the current cell.

5. The method of claim 4, further comprising:
decoding, by a decoder, information bits of the current cell using the combined softbits.

6. The method of claim 5, further comprising:
performing, by an error detector, error detection to detect whether the information bits of the current cell are decoded successfully.

7. The method of claim 6, wherein, if the information bits are decoded successfully, further comprising:
clearing from the buffer any stored softbits.

8. The method of claim 6, wherein, if the information bits are decoded successfully, further comprising:
repeating the regenerating and subtracting steps for the current cell; and
repeating the generating, combining, decoding, and error detecting steps for another cell.

9. The method of claim 6, wherein, if the information bits are decoded unsuccessfully, further comprising:
repeating the regenerating and subtracting steps for a future subframe; and
repeating the generating, combining, and decoding steps for the future subframe of the current cell.

10. The method of claim 1, wherein the communication signal having interference of one or more cells cancelled had the interference cancelled using a prospective successive interference cancellation method.

11. The method of claim 1, wherein the received communication signal is a physical broadcast channel (PBCH) signal.

12. The method of claim 11, wherein the PBCH signal comprises four subframes in four respective frames.

13. A wireless communication receiver, comprising:
a signal generator configured to regenerate, from a communication signal received from a plurality of cells, an interference signal of a current subframe of a cell for which information bits are known; and
a subtractor configured to subtract the regenerated interference signal from the received communication signal, or from a buffered communication signal having interference of one or more cells cancelled.

14. The wireless communication receiver of claim 13, further comprising:
a demodulator configured to generate softbits of the current subframe of a current cell.

15. The wireless communication receiver of claim 14, further comprising:
a buffer configured to store the softbits of the current subframe of the current cell.

16. The wireless communication receiver of claim 14, further comprising:
a combiner configured to combine the softbits of the current subframe of the current cell with any previously stored softbits of the current cell.

17. The wireless communication receiver of claim 16, further comprising:
a decoder configured to decode information bits of the current cell using the combined softbits.

18. The wireless communication receiver of claim 17, further comprising:
an error detector configured to perform error detection to determine whether the information bits of the current cell decoded successfully.

19. The wireless communication receiver of claim 18,
wherein the signal generator and the subtractor are further configured to perform the regenerating and subtracting for the current cell if the information bits decoded successfully, and
wherein the demodulator, the combiner, the decoder, and the error detector are further configured to perform the generating, combining, decoding, and error detecting, respectively, for another cell if the information bits decoded successfully.

20. The wireless communication receiver of claim 18,
wherein the signal generator and the subtractor are further configured to perform the regenerating and subtracting, respectively, for a future subframe of the current cell if the information bits did not decode successfully,
wherein the demodulator, buffer, combiner, and decoder are further configured to perform the generating, combining, and decoding, respectively, for a next subframe of the current cell, if the information bits did not decode successfully.

21. The wireless communication receiver of claim 13, wherein the received communication signal is a physical broadcast channel (PBCH) signal.

22. A mobile communication device comprising the wireless communication receiver of claim 13.

23. A computer program product embodied on a non-transitory computer-readable medium comprising program instructions configured such that when executed by processing circuitry causes the processing circuitry to implement the method of claim 1.

24. A wireless communication receiver, comprising:
a signal generating means for regenerating, from a communication signal received from a plurality of cells, an interference signal of a current subframe of a cell for which information bits are known; and
a subtracting means for subtracting the regenerated interference signal from the received communication signal, or from a buffered communication signal having interference of one or more cells cancelled.

25. The wireless communication receiver of claim 24, further comprising:
a demodulating means for generating softbits of the current subframe of the current cell.
